(19) United States
(12) Patent Application Publication
(10) Pub. No.: US 2006/0130084 A1
(43) Pub. Date: Jun. 15, 2006

(54) Optical disk drive

(75) Inventor: Hsien-Tsung Chiu, Taoyuan County (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/294,705

(22) Filed: Dec. 5, 2005

(30) Foreign Application Priority Data
Dec. 9, 2004 (TW) TW93138091

(51) Int. Cl. G11B 33/08; G11B 33/14

(52) U.S. Cl. 720/651

(57) ABSTRACT

An optical disk drive includes a case, a main body and a vibration reducing apparatus. The main body is disposed in the case. The vibration reducing apparatus is disposed between the case and the main body, generating a force at a distance to reduce vibration of the main body with respect to the case.

### BACKGROUND

The invention relates to an optical disk drive and more particularly, to a method of reducing vibration for an optical disk drive.

As optical media technology has rapidly improved in recent years, various optical disk drives are involved in applications as computer peripherals. Presently, most commercially available optical disk drives operate at rotational speeds over 10000 rpm.

However, an optical disk may be eccentric, such that, at high rotational speeds, centrifugal force due to imbalance of the disk increases and may lead to vibration or noise. The vibration creates instability that impairs the optical pickup head of the optical disk drive, so that error occurs in data readout, and the noise can be annoying or even hazardous to the user. Furthermore, reading from an unstable optical disk may also result in deterioration of the performance of the optical disk drive. Accordingly, elimination of vibration and noise at high rotational speeds is a major concern for manufacturers.

Conventionally, there are four methods to reduce vibration and noise in optical disk drives at high rotational speeds.

In one conventional method, extra weight is applied to the data readout device (i.e. the “mecha”) of the optical disk drive. This method directly increases the weight of the optical disk drive and attempts to reduce vibration. Unfortunately, vibration is not significantly reduced.

Another method of reducing the vibration of the optical disk drive uses an additional auto-balance system in the optical disk drive. In the auto-balance system, a balancing component is applied to the eccentric disk. In practical use, however, this method is limited by manufacturing factors such as concentricity or roughness, and it is not possible to apply a specific balancing component to deal with vibration and noise due of all types of eccentric disks. Obviously, the many specific components required create more costs.

The third method applies a dynamic vibration absorber in accordance with vibration theory to the optical disk drive. The dynamic vibration absorber includes an elastic block, i.e. an absorber, provided either above or under the main body of the optical disk drive. According to vibration theory, when the elastic block has a natural frequency equal to the harmonic frequency of the main body in vibration, the main body has a displacement of zero. That is, the elastic block absorbs vibration from the main body.

FIG. 1 shows a conventional dynamic vibration absorber commonly used in an optical disk drive. In FIG. 1, a plurality of dampers 12, elastic members, is provided between the block 10 and the main body 11. A plurality of vibration absorbing dampers 13 are provided between the main body 11 and the base supporting device (not shown). Screws fix the block 10, dampers 12 and vibration absorbing dampers 13 to the main body 11. The dynamic vibration absorber reduces vibration of the optical disk drive.

However, dampers 12 and the vibration absorbing dampers 13 are of different shapes and materials, not preferable in consideration of cost and manufacture of the optical disk drive.

The fourth method applies an ABS (auto balancer spindle) motor to reduce vibration of the optical disk drive. However, the ABS motor increases costs.

### SUMMARY

Consequently, there is a need to develop a vibration reducing apparatus for optical disk drives without the above-mentioned disadvantages.

Accordingly, optical disk drives and methods of reducing vibration for optical disk drives are provided. An exemplary embodiment of an optical disk drive comprises a case, a main body and a vibration reducing apparatus. The main body is disposed in the case. The vibration reducing apparatus is disposed between the case and the main body, generating a force at a distance to reduce vibration of the main body with respect to the case.

The vibration reducing apparatus comprises a first magnetic member, the main body is metal, and the force at a distance is generated between the first magnetic member and the main body to reduce vibration of the main body with respect to the case.

In some embodiments, the first magnetic member is a permanent magnet disposed on the case and the force at a distance is a magnetic force attracting the main body.

In some embodiments, the first magnetic member is an electromagnet and the force at a distance is a magnetic force attracting the main body. The electromagnet may comprise a coil and a conductor. The coil is disposed on the case, the conductor is disposed between the coil and the main body, and the conductor attracts the main body by the magnetic force when a current passes through the coil.

In some embodiments, the vibration reducing apparatus comprises a first magnetic member and a second magnetic member. The first magnetic member is disposed on the case and the force at a distance is generated between the first and second magnetic members to reduce vibration of the main body with respect to the case.

In some embodiments, the first magnetic member comprises metal, the second magnetic member is a permanent magnet disposed on the main body, and the force at a distance is a magnetic force attracting the first magnetic member.

In some embodiments, the first magnetic member comprises metal, the second magnetic member is an electromagnet, and the force at a distance is a magnetic force attracting the first magnetic member.

In some embodiments, the optical disk drive may further comprise a damper disposed between the case and the main body. The damper may comprise rubber.

An exemplary embodiment of a method of reducing vibration for an optical disk drive comprises providing a vibration reducing apparatus to reduce vibration of a main body in the optical disk drive by a force at a distance.

### DESCRIPTION OF THE DRAWINGS

The invention can be more fully understood by reading the subsequent detailed description in conjunction with the examples and references made to the accompanying drawings, wherein:

FIG. 1 is a schematic diagram of a conventional optical disk drive;

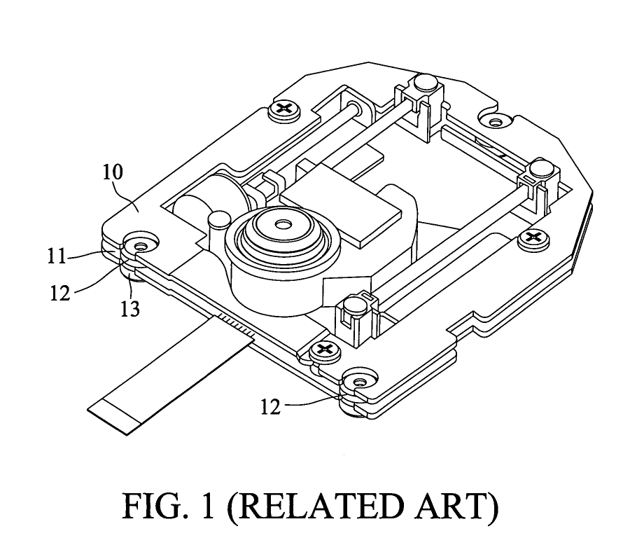

FIG. 2 is a schematic diagram of an optical disk drive of the invention;

FIG. 3A is a schematic diagram of an embodiment of an optical disk drive;

FIG. 3B is a schematic diagram of an embodiment of an optical disk drive;

FIG. 4 is a schematic diagram of an embodiment of an optical disk drive;

FIG. 5 is a schematic diagram of an embodiment of an optical disk drive; and

FIG. 6 is a schematic diagram of an embodiment of an optical disk drive.

### DETAILED DESCRIPTION

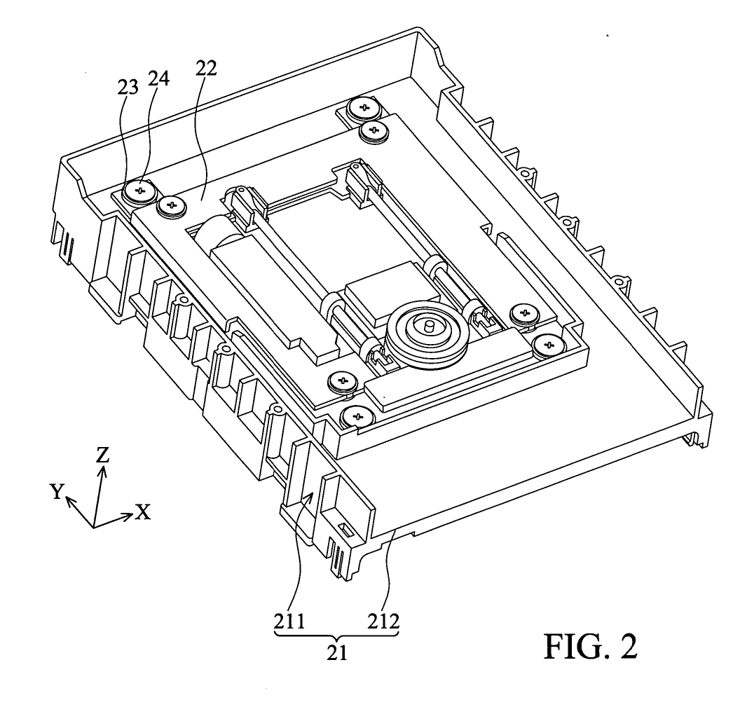

FIG. 2 shows an exemplary embodiment of an optical disk drive comprising a case 21 and a main body 22 disposed in the case 21; A vibration reducing apparatus (not shown) is employed to generate a force at a distance to reduce vibration of the main body 22 with respect to the case 21. The case 21 has a first side 211 and a second side 212. The first side 211 is perpendicular to a first direction (X-direction as shown in figure) and the second side 212 is perpendicular to a second direction (Y-direction as shown in figure). The vibration reducing apparatus reduces vibration of the main body 22 with respect to the case 21 in the first and second directions by the force at a distance. Furthermore, several dampers 23, such as rubber dampers, are disposed between the case 21 and the main body 22. Screws 24 are employed to engage the dampers 23, the case 21 and the main body 22. The dampers 23 decrease vibration of the main body 22 with respect to the case 21 in a third direction (Z-direction as shown in figure). The vibration reducing apparatus is described hereinafter.

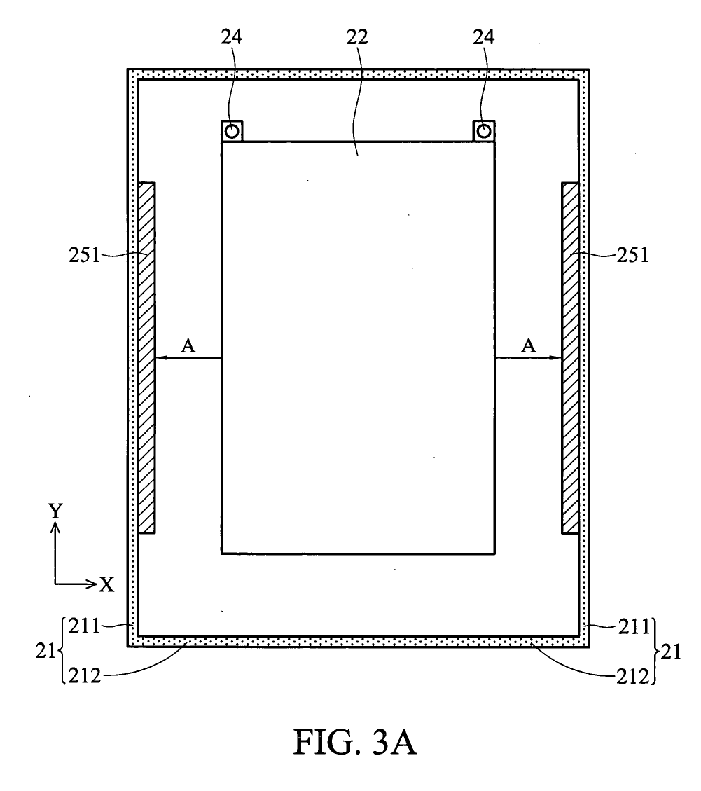

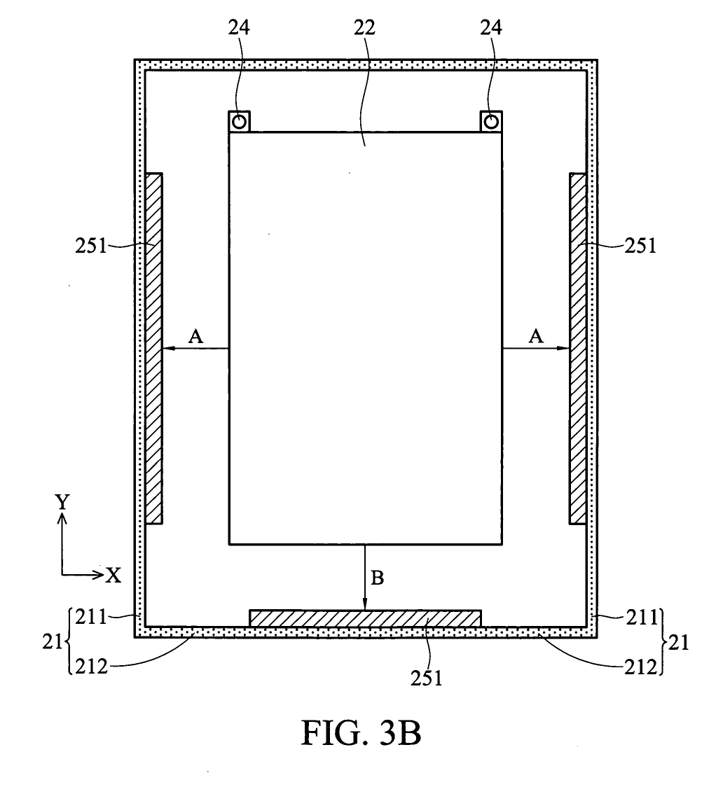

FIG. 3A is a top view of an exemplary embodiment of an optical disk drive comprising a case 21, a main body 22 and a vibration reducing apparatus. The vibration reducing apparatus comprises a first magnetic member. In this embodiment, the first magnetic member is a permanent magnet 251 disposed at a first side 211 of the case 21, extending in a second direction (Y-direction). Since the main body 22 is made of metal, a force at a distance (such as a magnetic force, as arrow A in figure) parallel to a first direction (X-direction) is generated between the main body 22 and the permanent magnet 251, so that the force at a distance attracts the main body 22 to decrease vibration of the main body 22 with respect to the case 21 in the first direction.

FIG. 3B is a top view of an exemplary embodiment of an optical disk drive, with similarities to the previous embodiment omitted. In this embodiment, a permanent magnet 251 is disposed at a second side 212 of the case 21, extending in the first direction (X-direction). Since the main body 22 is made of metal, a force at a distance (such as a magnetic force, as arrow B in figure) parallel to the second direction (Y-direction) is generated between the main body 22 and the permanent magnet 251, so that the force at a distance attracts the main body 22 to decrease vibration of the main body 22 with respect to the case 21 in the second direction.

Consequently, the first magnetic member and the dampers 23 disposed between the case 21 and the main body 22 significantly reduce vibration of the main body 22 with respect to the case 21 in the first direction (X-direction), the second direction (Y-direction) and the third direction (Z-direction).

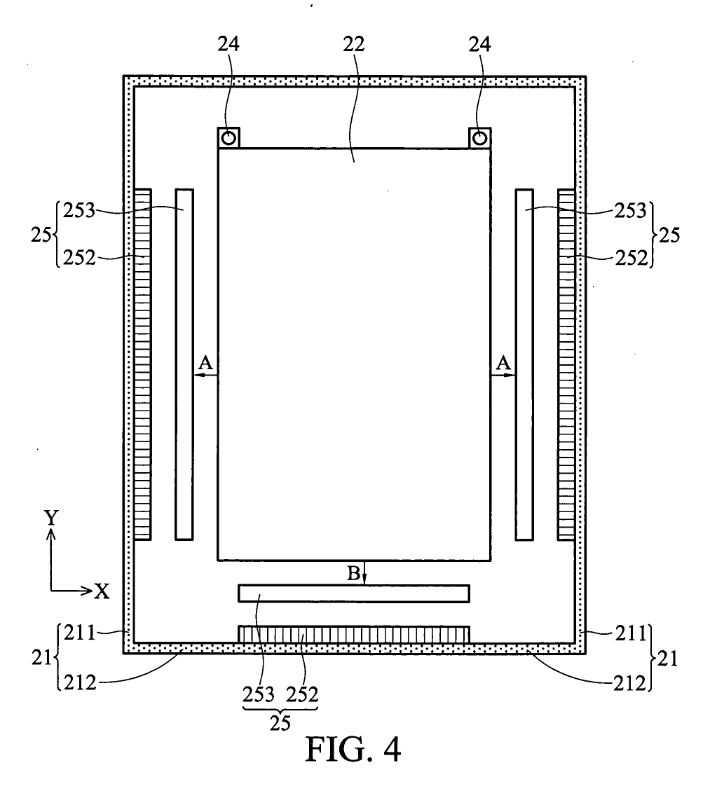

FIG. 4 is a top view of an exemplary embodiment of an optical disk drive, with similarities to the previous embodiments omitted. In this embodiment, the first magnetic member is an electromagnet comprising a coil 252 and a conductor 253. The coil 252 is disposed at the first side 211 of the case 21, extending in the second direction (Y-direction). The conductor 253 is disposed between the main body 22 and the coil 252. Since the main body 22 is made of metal, a force at a distance (such as a magnetic force, as arrow A in figure) parallel to the first direction (X-direction) is generated between the main body 22 and the conductor 253 when a current passes through the coil 252, so that the force at a distance attracts the main body 22 to decrease vibration of the main body 22 with respect to the case 21 in the first direction.

Furthermore, another coil 252 is disposed at the second side 212 of the case 21, extending in the first direction (X-direction). Another conductor 253 is disposed between the main body 22 and the coil 252. Since the main body 22 is made of metal, a force at a distance (such as a magnetic force, as arrow B in figure) parallel to the second direction (Y-direction) is generated between the main body 22 and the conductor 253 when a current passes through the coil 252, so that the force at a distance attracts the main body 22 to decrease vibration of the main body 22 with respect to the case 21 in the second direction.

Consequently, the first magnetic member and the dampers 23 disposed between the case 21 and the main body 22 significantly reduce vibration of the main body 22 with respect to the case 21 in the first direction (X-direction), the second direction (Y-direction) and the third direction (Z-direction).

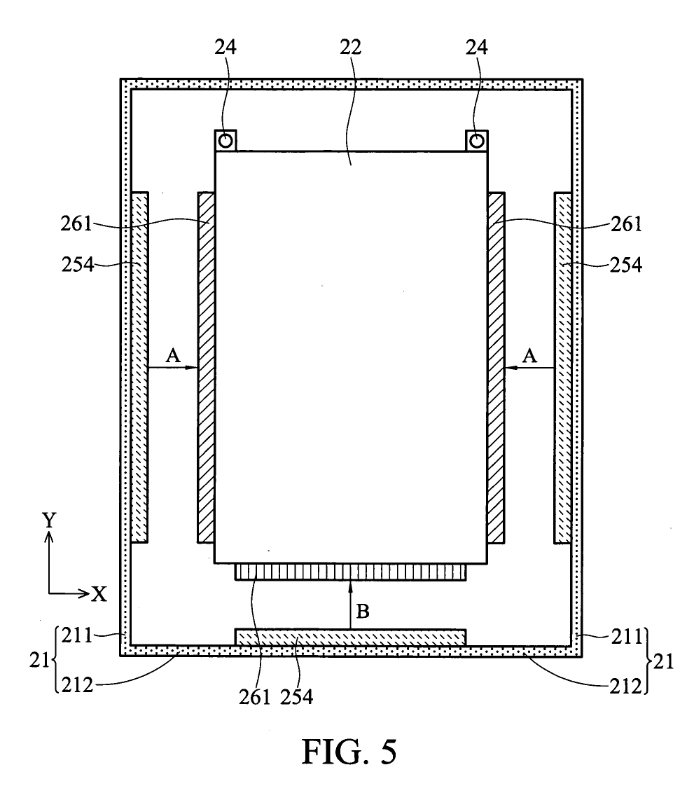

FIG. 5 is a top view of an exemplary embodiment of an optical disk drive, with similarities to the previous embodiments omitted. In this embodiment, the vibration reducing apparatus comprises a first magnetic member and a second magnetic member. The first magnetic member comprises a metal 254, such as a sheet iron, disposed at the first side 211 of the case 21, extending in the second direction (Y-direction). The second magnetic is a permanent magnet 261 disposed on the main body 22, corresponding to the metal 254. Therefore, a force at a distance (such as a magnetic force, as arrow A in figure) parallel to the first direction (X-direction) is generated between the metal 254 and the permanent magnet 261, so that the force at a distance attracts the metal 254 to decrease vibration of the main body 22 with respect to the case 21 in the first direction.

Furthermore, another metal 254 is disposed at the second side 212 of the case 21, extending in the first direction (X-direction). Another permanent magnet 261 is disposed on the main body 22, corresponding to the metal 254. Therefore, a force at a distance (such as a magnetic force, as arrow B in figure) parallel to the second direction (Y-direction) is generated between the metal 254 and the permanent magnet 261, so that the force at a distance attracts the metal 254 to decrease vibration of the main body 22 with respect to the case 21 in the second direction.

Consequently, the first and second magnetic members and the dampers 23 disposed between the case 21 and the main body 22 significantly reduce vibration of the main body 22 with respect to the case 21 in the first direction (X-direction), the second direction (Y-direction) and the third direction (Z-direction).

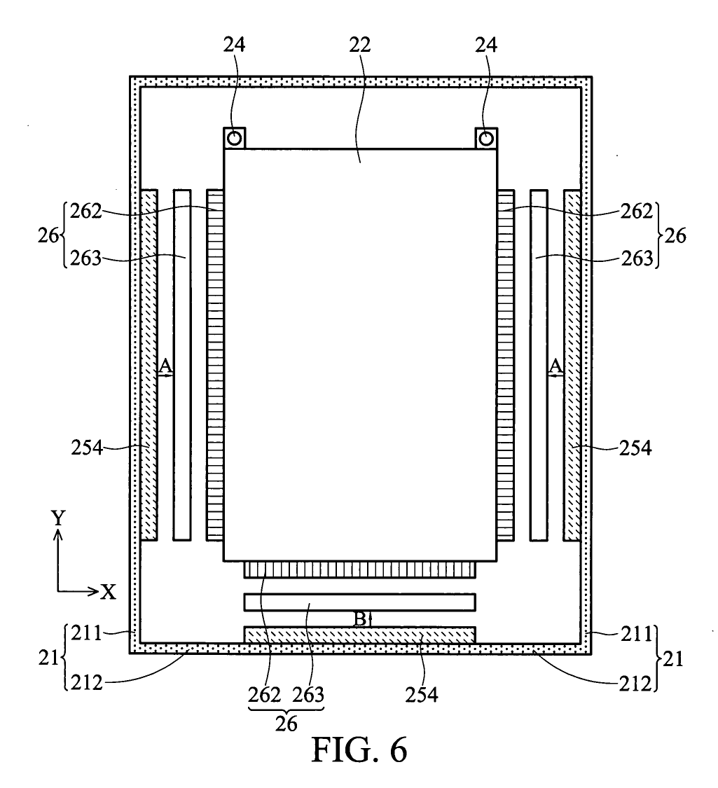

FIG. 6 is a top view of an exemplary embodiment of an optical disk drive, with similarities to the previous embodiments omitted. In this embodiment, the vibration reducing apparatus comprises a first magnetic member and a second magnetic member 26. The first magnetic member comprises a metal 254, such as a sheet iron, disposed at the first side 211 of the case 21, extending in the second direction (Y-direction). The second magnetic 26 is an electromagnet comprising a coil 262 and a conductor 263. The coil 262 is disposed on the main body 22, corresponding to the metal 254. The conductor 263 is disposed between the metal 254 and the coil 262. Therefore, a force at a distance (such as a magnetic force, as arrow A in figure) parallel to the first direction (X-direction) is generated between the metal 254 and the conductor 263 when a current passes through the coil 262, so that the force at a distance attracts the metal 254 to decrease vibration of the main body 22 with respect to the case 21 in the first direction.

Furthermore, another metal 254 is disposed at the second side 212 of the case 21, extending in the first direction (X-direction). Another coil 262 is disposed on the main body 22, corresponding to the metal 254. Another conductor 253 is disposed between the metal 254 and the coil 262. Therefore, a force at a distance (such as a magnetic force, as arrow B in figure) parallel to the second direction (Y-direction) is generated between the metal 254 and the conductor 263 when a current passes through the coil 262, so that the force at a distance attracts the metal 254 to decrease vibration of the main body 22 with respect to the case 21 in the second direction.

Consequently, the first magnetic member, the second magnetic member 26 and the dampers 23 disposed between the case 21 and the main body 22 significantly reduce vibration of the main body 22 with respect to the case 21 in the first direction (X-direction), the second direction (Y-direction) and the third direction (Z-direction).

While the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An optical disk drive, comprising:
a case;
a main body disposed in the case; and
a vibration reducing apparatus disposed between the case and the main body, generating a force at a distance to reduce vibration of the main body with respect to the case.

2. The optical disk drive as claimed in claim 1, wherein the vibration reducing apparatus comprises a first magnetic member, the main body comprises metal, and the force at a distance is generated between the first magnetic member and the main body to reduce vibration of the main body with respect to the case.

3. The optical disk drive as claimed in claim 2, wherein the first magnetic member is a permanent magnet disposed on the case and the force at a distance is a magnetic force attracting the main body.

4. The optical disk drive as claimed in claim 2, wherein the first magnetic member is an electromagnet and the force at a distance is a magnetic force attracting the main body.

5. The optical disk drive as claimed in claim 4, wherein the electromagnet comprises a coil and a conductor, the coil is disposed on the case, the conductor is disposed between the coil and the main body, and the conductor attracts the main body by the magnetic force when a current passes through the coil.

6. The optical disk drive as claimed in claim 1, wherein the vibration reducing apparatus comprises a first magnetic member and a second magnetic member, the first magnetic member is disposed on the case, and the force at a distance is generated between the first and second magnetic members to reduce vibration of the main body with respect to the case.

7. The optical disk drive as claimed in claim 6, wherein the first magnetic member comprises metal, the second magnetic member is a permanent magnet disposed on the main body, and the force at a distance is a magnetic force attracting the first magnetic member.

8. The optical disk drive as claimed in claim 6, wherein the first magnetic member comprises metal, the second magnetic member is an electromagnet, and the force at a distance is a magnetic force attracting the first magnetic member.

9. The optical disk drive as claimed in claim 8, wherein the electromagnet comprises a coil and a conductor, the coil is disposed on the main body, the conductor is disposed between the coil and the case, and the conductor attracts the first magnetic member by the magnetic force when a current passes through the coil.

10. The optical disk drive as claimed in claim 1, further comprising a damper disposed between the case and the main body.

11. A method of reducing vibration for an optical disk drive, comprising providing a vibration reducing apparatus to reduce vibration of a main body in the optical disk drive by a force at a distance.

12. The method as claimed in claim 11, further comprising providing a case, wherein the main body is disposed in the case and the vibration reducing apparatus is disposed between the case and the main body.

13. The method as claimed in claim 12, wherein the case has a first side and a second side, the first side is perpendicular to a first direction, and the second side is perpendicular to a second direction.

14. The method as claimed in claim 13, wherein the vibration reducing apparatus further comprises a first magnetic member, the main body comprises metal, and the force at a distance is generated between the first magnetic member and the main body to reduce vibration of the main body with respect to the case.

15. The method as claimed in claim 14, wherein the first magnetic member is disposed at the first side so that the force at a distance is parallel to the first direction to reduce vibration of the main body with respect to the case in the first direction.

16. The method as claimed in claim 14, wherein the first magnetic member is disposed at the second side so that the force at a distance is parallel to the second direction to reduce vibration of the main body in the second direction.

17. The method as claimed in claim 14, wherein the first magnetic member is an electromagnet and the force at a distance is a magnetic force attracting the main body.

18. The method as claimed in claim 13, wherein the vibration reducing apparatus comprises first magnetic members and a second magnetic member, the first magnetic members are disposed on the first side and second side of the case, respectively, and the force at a distance is generated between the first and second magnetic members to reduce vibration of the main body with respect to the case.

19. The method as claimed in claim 18, wherein the first magnetic member comprises metal, the second magnetic member is a permanent magnet disposed on the main body, and the force at a distance is a magnetic force attracting the first magnetic member.

20. The method as claimed in claim 18, wherein the first magnetic member comprises metal, the second magnetic member is an electromagnet, and the force at a distance is a magnetic force attracting the first magnetic member.
